(19) United States
(12) Patent Application Publication
(10) Pub. No.: US 2008/0270033 A1
(43) Pub. Date: Oct. 30, 2008

(54) Methods of hydrocarbon detection using spectral energy analysis

(75) Inventors: Robert W. Wiley, Sugar Land, TX (US); Peter H. Wilson, Houston, TX (US); Scott W. Peters, Houston, TX (US)

Correspondence Address: OSHA LIANG L.L.P., 1221 MCKINNEY STREET, SUITE 2800, HOUSTON, TX, 77010, US

(73) Assignee: APEX SPECTRAL TECHNOLOGY, INC., Houston, TX (US)

(21) Appl. No.: 11/788,910

(22) Filed: Apr. 23, 2007

Related U.S. Application Data
(63) Continuation-in-part of application No. 10/910,856, filed on Aug. 4, 2004, now Pat. No. 7,243,029.
Application No. 10/910,856 is a continuation-in-part of application No. 10/643,845, filed on Aug. 19, 2003, now abandoned.

(51) Int. Cl. G01V 1/28

(52) U.S. Cl. 702/13

(57) ABSTRACT

A method for detecting hydrocarbons includes obtaining seismic trace data for a region of interest; and processing the seismic trace data to calculate a Smooth Signal Spectrum for each of a plurality of locations in the region of interest. A system for detecting hydrocarbons includes a processor and a memory, wherein the memory comprises a program having instructions for: obtaining seismic trace data for a region of interest; and processing the seismic trace data to calculate a Smooth Signal Spectrum for each of a plurality of locations in the region of interest.

### REFERENCE TO RELATED APPLICATIONS

This is a Continuation-In-Part and claims benefit of U.S. application Ser. No. 10/910,856, filed on Aug. 4, 2004, which is a Continuation-In-Part of U.S. application Ser. No. 10/643,845 filed on Aug. 19, 2003. These two applications are incorporated by reference in their entirety.

### BACKGROUND

Existing seismic exploration direct hydrocarbon detection methods primarily focus on the properties of the sound-reflecting boundaries present in the earth. These methods are founded on the theory that the strength of the sound reflection from the boundary itself is determined by certain lithological properties of rock within the layer above and the layer below a given boundary.

However, such reflection based methods are far from perfect. Reflections at each point on a boundary depends on at least eight variables (P-wave velocity above, S wave velocity above, density above, P wave velocity below, S wave velocity below, density below, angle of the incident ray path and bed thicknesses which may cause tuning effects or the lack thereof). The interplay between these variables makes it difficult to determine any particular one with accuracy.

Therefore methods that do not rely on the strength of the reflection boundary for direct detection are desirable.

### SUMMARY

One aspect of the invention relates to methods for detecting hydrocarbons. A method in accordance with one embodiment of the invention includes obtaining seismic trace data for a region of interest; and processing the seismic trace data to calculate a Smooth Signal Spectrum for each of a plurality of locations in the region of interest.

Another aspect of the invention relates to systems for detecting hydrocarbons. A system in accordance with one embodiment of the invention includes a processor and a memory, wherein the memory comprises a program having instructions for: obtaining seismic trace data for a region of interest; and processing the seismic trace data to calculate a Smooth Signal Spectrum for each of a plurality of locations in the region of interest.

Other aspects and advantages of the invention will be apparent from the following description and the appended claims.

### BRIEF DESCRIPTION OF THE DRAWINGS

Reference will be made to the accompanying drawings which are described as follows.

FIG. 1 shows an illustration in which hydrocarbon detection methods may be used;

FIG. 2 shows a block diagram of various illustrative hydrocarbon detection systems;

FIG. 3 shows a flowchart of an illustrative seismic data acquisition method;

FIG. 4 shows a flowchart of an illustrative hydrocarbon detection method;

FIG. 5 shows a flowchart of an illustrative time interpolation method;

FIG. 6 shows a flowchart of an illustrative method to remove reflection energy from a seismic segment thereby creating a Smooth Signal Spectrum;

FIG. 7 shows graphically the dominant frequency measurement on the Smooth Signal Spectrum;

FIG. 8 shows graphically the spectrum breadth measurement on the Smooth Signal Spectrum based on measuring the width of the Smooth Signal Spectrum.

FIG. 9 shows graphically the spectrum breadth measurement on the Smooth Signal Spectrum based on measuring the length of a portion of the Smooth Signal Spectrum curve.

FIG. 10 shows a graph illustrating a three-dimensional output in accordance with one embodiment of the invention.

FIG. 11 shows another graph illustrating a three-dimensional output in accordance with another embodiment of the invention.

### DETAILED DESCRIPTION

Embodiments of the invention relate to methods and systems for hydrocarbon detection using seismic data. Specifically, embodiments of the invention rely upon the dominant frequency (ω_{D}) and breadth of a Smooth Signal Spectrum computed from the seismic data to identify potential hydrocarbon reservoirs. In accordance with embodiments of the invention, hydrocarbon reservoirs may be identified as shifts or changes in the dominant frequency (ω_{D}) and/or breadth of a Smooth Signal Spectrum in a region of interest. The following discussion covers various illustrative embodiments of the invention. One skilled in the art will appreciate that the following description is for illustrative purpose only and various modifications are possible without departing from the scope of the invention.

Various hydrocarbon detection systems and methods are disclosed below. These systems and methods are not based on reflection-boundary analysis, but instead are based on changes to the seismic waves as they propagate through subsurface formations. When the seismic waves propagate through subsurface formations, their energies are attenuated to various extents and in various manners, depending on the lithological properties of the formation including the matrix type, porosity, permeability, fluid type, temperature, and pressure along the paths of propagation.

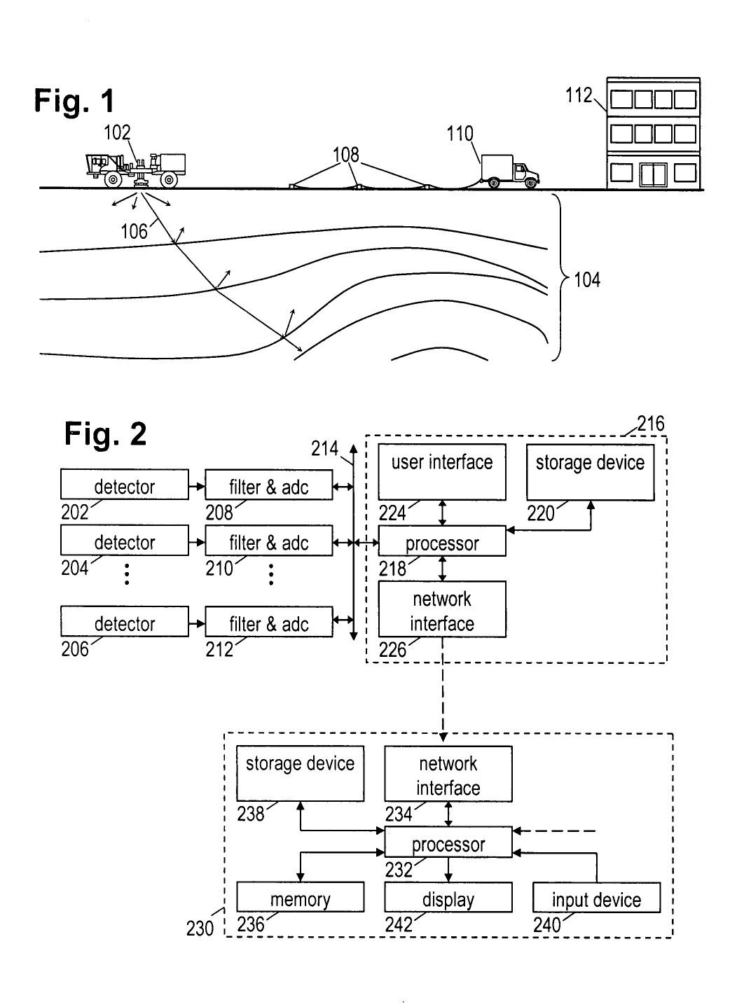

FIG. 1 shows an illustrative context for use of the disclosed systems and methods. A seismic source 102 such as a vibrator truck, a small explosion, or an air gun (in underwater surveys), generates seismic waves that propagate through subsurface formations 104. As shown by a selected propagation path 106, the seismic waves reflect and refract at boundaries between subsurface formations 104, and eventually some of the reflected seismic waves reach an array of receivers 108. The array typically includes numerous receivers 108 spaced in a grid pattern. Receivers 108 convert seismic waves into electrical signals that are then recorded at a recording facility 110 such as a recorder truck. Eventually, the recorded data is transported or transmitted to a central facility 112 for analysis.

Seismic source 102 typically fires multiple times at different locations relative to the array of receivers 108. The array of receivers 108 may then be moved and the process may be repeated many times. The use of multiple source and receiver locations allows data from different propagation paths to be combined in a manner that attenuates noise.

FIG. 2 shows a block diagram of various systems and devices employed in gathering and analyzing seismic data. Detectors 202, 204, and 206 are transducers that convert seismic waves into electrical signals that are then amplified. Analog-to-digital converter (ADC) blocks 208, 210, and 212 receive the amplified electrical signals from detectors 202, 204, and 206, respectively. ADC blocks 208, 210, and 212 filter the amplified electrical signals and convert them to digital form. Digital sampling is performed at an interval of, for example, 1-4 milliseconds. Each receiver 108 may include at least one detector and ADC block.

A bus 214 couples ADC blocks 208, 210, and 212 to a recording system 216. Bus 214 is a simplified representation of multiple wires, cables and/or wireless connections with corresponding adapters.

Illustrative recording system 216 may include a processor 218, a storage device 220, a user interface 224, and a network interface 226. Processor 218, for example, may collect and format the digital data from the receivers and may store the digital data in files on storage device 220. Alternatively, the digital data may be streamed over a network for remote storage. The files may include header information regarding the data in the file, e.g., the number of array receivers, the bit resolution of the digitized samples, the sampling rate, the starting time and length of the recording period, and the positions of the source and each receiver in the array. The seismic data samples may be multiplexed and written into the file as they are received. A new file may be created for each firing of the seismic source 102.

The manner of collecting and recording the data may be controlled via a user interface 224. Typically, user interface 224 includes a display upon which processor 218 shows options that can be configured by the user, and a keypad or other input device that the user can use to communicate the desired configuration to the processor 218. Once surveying is completed, the seismic data files may be transported or transmitted to a hydrocarbon detection system 230 via network interface 226.

In accordance with one embodiment of the invention, hydrocarbon detection system 230 may be a general-purpose computer configured for operation as a hydrocarbon detection system through the use of software. System 230 may include a processor 232, a network interface 234, a memory device 236, a storage device 238, an input device 240, and a display device 242. Network interface 234 may couple processor 232 to recording system 216 allowing processor 232 to retrieve software and data stored on recording system 216. Software stored on memory device 236 may configure processor 232 to interact with a user via input device 240 and display 242.

The user may cause processor 232 to perform a seismic data file processing program stored on storage device 238. Processor 232 typically begins program execution by causing some or all of the program to be copied into memory 236 for fast access. With guidance from the user, the data file processing program may retrieve seismic data files from storage device 238. The data file processing program may then perform pre-stack processing on the data, stacks the data, and stores the stacked data as a new seismic data set.

The user may then cause processor 232 to execute a hydrocarbon detection program. As with the data file processing program, processor 232 may begin execution by coping the hydrocarbon detection program into memory 236. With guidance from the user, the hydrocarbon detection program may configure processor 232 to retrieve traces from the raw seismic data files and/or from the stacked seismic data set. The hydrocarbon detection program may configure processor 232 to process the traces as described in greater detail below, eventually producing a section(s) or volume(s) for viewing by the user.

The following discussion describes various illustrative methods implemented by system 230. The corresponding figures show exemplary methods in the form of flowcharts having blocks to represent component operations, and arrows to represent potential operation sequences. System 230 may carry out the component operations of the various methods in the sequences shown or in a different order, or alternatively, many of the operations may be re-ordered, or performed concurrently. The methods are ultimately carried out by hardware, but the methods' control logic may be implemented in the software, firmware, and or hardware of system 230.

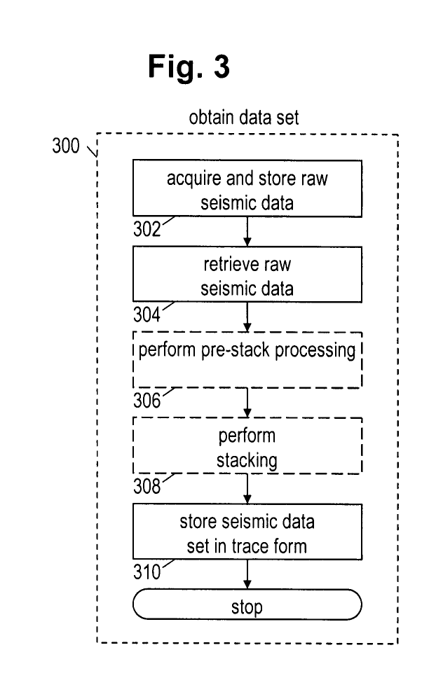

In accordance with one embodiment of the invention, FIG. 3 shows a flowchart of an illustrative method 300 to obtain a seismic data set, including optional operations performed by a seismic data file processing program. In block 302, a recording system (shown as 216 in FIG. 2) acquires and records raw seismic data as described previously. In block 304, a hydrocarbon detection system (shown as 230 in FIG. 2) retrieves (with guidance from a user) the raw seismic data and reorders the digitized samples. As noted previously, recording system 216 may store the data as it is acquired. System 230 may convert the data file format to a trace-based format, i.e., the digitized samples are reordered to provide a separate time sequence for each receiver. System 230 may further associate each trace with a map location, which, for example, may be halfway between the receiver and the seismic source.

Method 300 includes two optional blocks 306 and 308, which can be omitted independently of each other. In block 306, system 230 may perform pre-stack processing. In block 308, system 230 may identify for each map location those traces having the map location as a midpoint between the receiver and the seismic source. These traces may be sorted based on offset, i.e., the distance between the map location and the receiver. System 230 then averages (“stacks”) the identified traces having a common offset. Note that in some stacking variations, system 230 may stack all the identified traces for a map location, after first stretching the traces in the time domain as a function of offset and estimated velocities. Stacking operation 308 further enhances the signal to noise ratio of the traces. In block 310, system 230 may store the reformatted (and optionally filtered and stacked) seismic data set on storage device (shown as 238 in FIG. 2).

Most seismic data processing software is configured to access seismic data in this trace-based format. Accordingly, system 230 may perform multiple hydrocarbon detection techniques without repeating the foregoing operations.

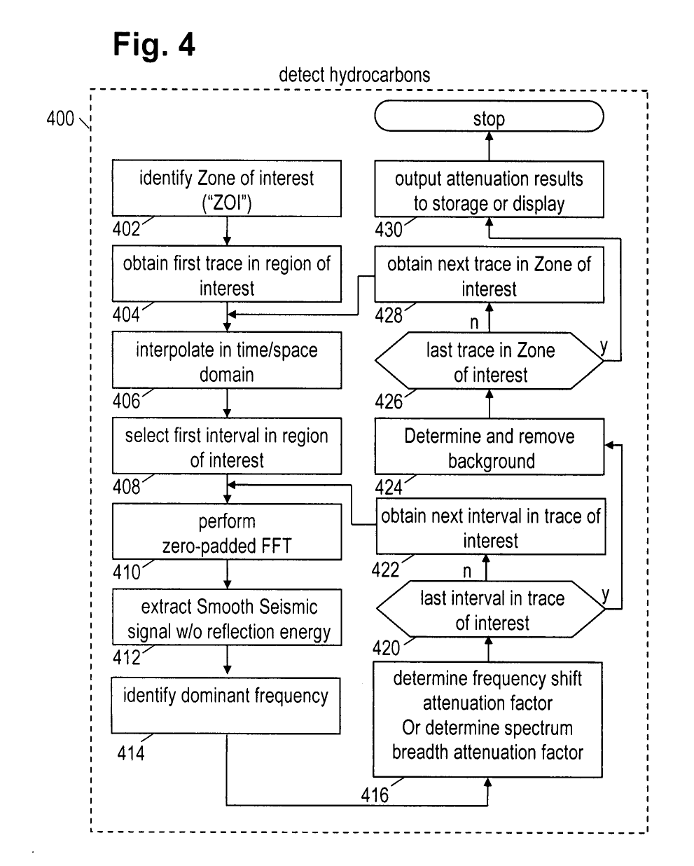

FIG. 4 shows a flowchart illustration of a hydrocarbon detection method 400 in accordance with one embodiment of the invention. Beginning in block 402, system 230 identifies (with guidance from a user) a region of interest in the seismic dataset. The region of interest may include the entire seismic data volume, or be a subset of the dataset. In block 404, system 230 begins working through the region of interest systematically, obtaining a first trace from the seismic data set.

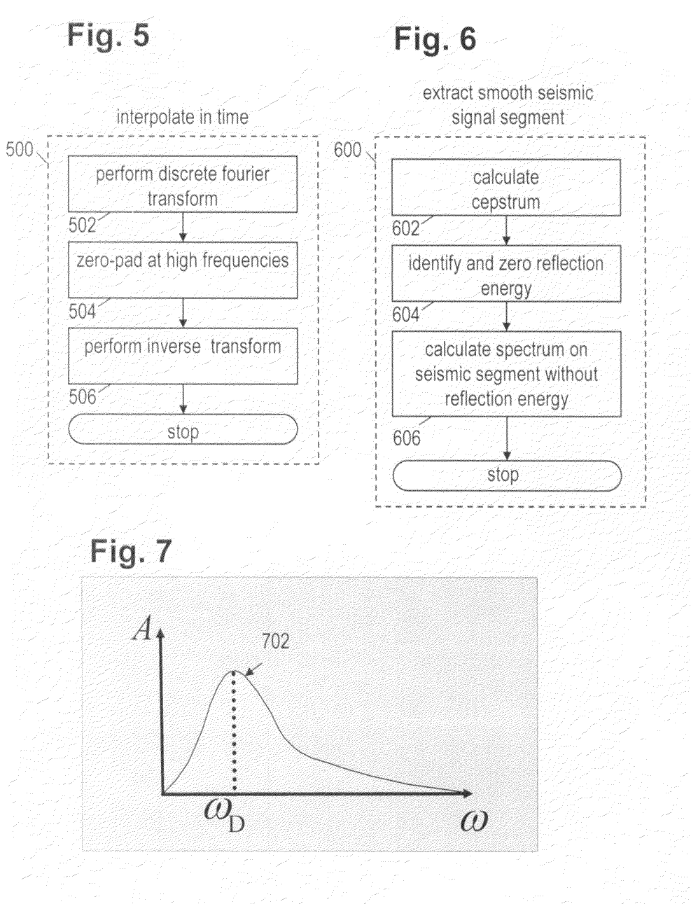

In block 406, system 230 interpolates the trace in the time domain. Time interpolation is an optional operation that is designed to increase the accuracy of subsequent operations. Accordingly, the degree of interpolation is customizable, and may be chosen to be high enough to provide reliable spectra within small time windows. For example, a trace that is originally sampled every 4 milliseconds may be interpolated by a factor of 8 to provide 256 time samples within a 128 millisecond time window. An illustrative method of time interpolation is described further below with reference to FIG. 5.

In block 408, system 230 begins processing the trace systematically, obtaining time samples from a first trace interval in the region of interest. The interval is the size of the selected time window, e.g., 100 milliseconds. This interval represents the first position of a “sliding window” that system 230 moves through the region of interest along the trace.

In block 410, system 230 performs a Fourier Transform (such as a Fast Fourier Transform, or “FFT”) to determine a discrete frequency spectrum. Additionally, the seismic trace may optionally be zero padded before the FFT in this step in order to increase the spectral resolution. The spectral resolution of the transform depends on the number of points within the time interval. By padding the time samples with zeros, the number of points within the time interval (and hence the spectral resolution) can be increased.

In block 412, system 230 extracts the smooth part of the seismic signal (i.e. the “Smooth Signal” spectrum) from the trace segment information leaving behind the reflection energy. An illustrative method to extract the Smooth Signal Spectrum without reflection energy is described further below with reference to FIG. 6.

An example of the Smooth Signal Spectrum is shown in FIG. 7 as curve 702. The maximum amplitude defines the dominant frequency ω_{D}. Attenuation of seismic signals may result when the seismic wave passes through a reservoir where the fluid is gas mixed with liquid hydrocarbons or liquid hydrocarbons mixed with gas. Such attenuation sometimes causes the dominant frequency ω_{D} of the Smooth Signal Spectrum to shift higher or lower. Therefore, the dominant frequency ω_{D} of the Smooth Signal Spectrum may be used as a hydrocarbon indicator. The dominant frequency measurement ω_{D} may be expressed as:

A(ω_{D})≧A(ω) for all values of ω, (1)

where 0≦ω≦ω_{nyquist}; ω is frequency; ω_{D} is the dominant frequency; ω_{nyquist} is the nyquist frequency determined from the sample rate; and A(ω) is the amplitude of the Smooth Signal Spectrum curve at frequency ω.

This spectral energy attenuation factor ω_{D} is independent of amplitude but is dependent on the interplay of, among other things, reservoir fluid properties (gas, oil, water and/or a mixture thereof), reservoir porosity, permeability, and the spectral shape and energy level of the seismic wave just before it enters the hydrocarbon reservoir.

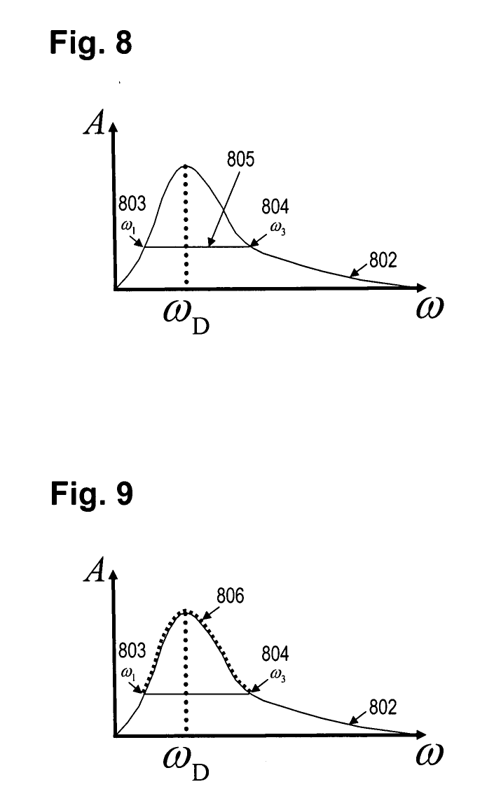

FIG. 8 shows the Smooth Signal Spectrum again as curve 802. Attenuation of seismic signals may result when the seismic wave passes through a reservoir where the fluid is gas mixed with liquid hydrocarbons or liquid hydrocarbons mixed with gas. Such attenuation sometimes causes the breadth of Smooth Signal Spectrum curve 802 to change (i.e. broaden or narrow). Therefore, the Smooth Signal Spectrum breadth Q_{B} may be a hydrocarbon indicator. Q_{B} can be measured by determining the amplitude of the spectrum at ω_{D}, defining a noise-to-signal ratio (NSR) of the data and then finding the two points on the Smooth Signal Spectrum curve, one has a frequency less than ω_{D} (i.e. ω₁ labeled as 803) and the other has a frequency greater than ω_{D}, (i.e. ω₃ labeled 804), where the Smooth Signal Spectrum curve crosses the noise-to-signal ratio 805. The frequency difference between ω₁ and ω₃ may be defined as Q_{B}

That is, the spectrum breadth measurement may be expressed as:

Q_{B}=ω₃−ω₁ (2)

One of ordinary skill in the art would appreciate that ω₁ and ω₃ may be identified with any suitable methods. One approach is illustrated as follows:

A(ω_{D})≧A(ω) for all values of ω in the range of 0 to ω_{nyquist}

A(ω₁−Δω)<A(ω₁)<A(ω₁+Δω)

NSR*A(ω_{D})−ε<A(ω₁)<NSR*A(ω_{D})+ε

A(ω₃−Δω)>A(ω₃)>A(ω₃+Δω)

NSR*A(ω_{D})−ε<A(ω₃)<NSR*A(ω_{D})+ε

wherein ω is frequency, ω_{D} is the dominant frequency, Q_{B} is the breadth of the Smooth Signal Spectrum, A(ω) is the amplitude of the Smooth Signal Spectrum curve at frequency ω, NSR is the noise-to-signal ratio of the data or any other percent threshold of the maximum amplitude, and ε is a selected value relating to the noise threshold.

Alternatively, the breath measurement, Q_{B}, can be measured by computing the line integral along the Smooth Signal Spectrum curve between the points ω₁ and ω₃, which may be expressed as in equation (3) and illustrated in FIG. 9. As shown in FIG. 9, the length of the curve segment 806, which corresponds to the portion of the Smooth Curve Spectrum 802 between points 803 (at ω₁) and point 804 (at ω₃), may be used as an alternative measure of the breadth of the peak.

A_{B}= [symbol] _{ω}_{₁}^{ω}^{₃}A(ω)dω (3)

This spectral energy attenuation factor Q_{B} is independent of amplitudes, but dependent on the interplay of, for example, reservoir fluid properties (gas, oil, water and a mixture thereof), reservoir porosity, reservoir permeability, and the spectrum shape and energy level of the Smooth Signal as it exists just before it enters the hydrocarbon reservoir.

Referring again to FIG. 4, in block 416, system 230 may identify the dominant frequency ω_{D} of the Smooth Signal Spectrum or Smooth Signal Spectrum breadth attenuation factor Q_{B}. A minimum and maximum or threshold technique may be employed to determine or define the values of the spectrum breadth measurement Q_{B}. Alternatively, a line integral technique may be employed to determine the values of the spectrum breadth measurement Q_{B}.

In block 420, system 230 determines whether the last time interval in the region of interest for the trace has been processed. If not, system 230 increments the sliding time window to its next position along the trace in block 422, and repeats the operations of blocks 410-422 until all the trace's time intervals that are in the region of interest have been processed. The sliding increment provided in block 422 is configurable. Once the dominant frequency value ω_{D} and attenuation factor Q_{B} have been determined for each time window position in the region of interest on a trace, system 230 progresses to block 424 from block 422. At this point, system 230 contains values for ω_{D} and Q_{B} at each sample and they can be shown as curves, i.e., plotted as a function of time for the trace. These ω_{D} and Q_{B} datasets are of interest and may be saved for later processing. However, in accordance with some embodiments of the invention, the anomalies in the ω_{D} and/or Q_{B} datasets are of particular interest. Thus, in block 424, system 230 may process the ω_{D} and/or Q_{B} datasets to identify anomalies.

The processing in block 424 may take various forms. As one example, system 230 determines a background curve for each absorption factor by using a “best fit” straight line or slowly changing curve (e.g., a low-order polynomial curve). System 230 then determines that an anomaly exists where the ω_{D} or Q_{B} curve deviates from the “best fit” straight line or curve by more than a threshold amount. Different threshold amounts may be configured by the user. “Anomaly” as used herein refers to substantially different values for ω_{D} and/or Q_{B} in a region as compared with the neighboring regions.

In block 426, system 230 determines whether the last trace in the region of interest has been processed, for example, to measure spectral energy attenuation factor(s) anomalies. If not, system 230 selects the next trace in block 428, and repeats blocks 410-428 until values for ω_{D} and Q_{B} have been calculated in all traces in the region of interest.

Once all selected traces have been processed, in block 430 system 230 displays the ω_{D} and/or Q_{B} anomalies. The display format is configurable. Thus, the anomalies may be viewed as a function of one dimension (e.g. a time axis for a trace), two dimensions (e.g. a map view, a contour map, a color coded map, or a vertical cross-section), or three dimensions, (e.g. a plan view map of the results shown in color to represent the magnitude of the results over lain on top of a time or depth structure maps) or more. ω_{D} and/or Q_{B} anomaly measurements may also be overlaid on views of seismic trace data in section view or in plan view by contours (e.g. time or depth contours).

Processing of typical seismic data requires the use of a sliding time-window having a size between 40 and 200 milliseconds. A window of this size typically does not contain enough signal samples (data points) to afford reliable computation of spectra using the conventional FFT. Therefore, the seismic traces may need to be interpolated, and the interpolation procedure preferably are frequency-domain invariant.

While any suitable interpolation method may be used with embodiments of the invention, FIG. 5 shows an illustrative interpolation method 500, which, for example, may be used for implementing an operation of block 406 in FIG. 4. Beginning in block 502, system 230 performs a Fourier Transform (e.g., a fast Fourier Transform “FFT”) on the trace, thereby producing a discrete frequency spectrum of the trace. Interpolation may be then accomplished by zero padding (i.e., increasing the number of data points) in the discrete frequency spectrum, e.g., increasing the number of data points from n to 8n to interpolate by a factor of 8. The zero padding may be by adding data points to the high frequency end beyond the original Nyquist frequency so as to extend the Nyquist frequency to a new, desired frequency (block 504). Alternatively, the zero padding may be accomplished by adding the points to the low frequency end, or by dispersing the additional data points between the original points in the discrete frequency spectrum.

In block 506, system 230 performs an inverse Fourier Transform of the padded discrete frequency spectrum. This inverse transform results in a desired, interpolated time-domain trace. Interpolation of the seismic traces permits the computation of more reliable instantaneous spectrum after Fourier Transformation. This in turn allows Smooth Signals spectrums to be reliably extracted from a Cepstrum. A Cepstrum results from Fourier Transformation of a “spectrum,” i.e., treating the “spectrum” as signals. Specifically, a Cepstrum is the FT of the log (with unwrapped phase) of the FT.

FIG. 6 shows an illustrative smooth seismic signal extraction method 600, which is suitable for implementing an operation of block 412 in FIG. 4. Beginning in block 602, system 230 operates on a discrete frequency spectrum T(w) to calculate a real Cepstrum C(t). The real Cepstrum may be calculated as:

C(t)=FT{ln|T(w)|} (4)

In words, system 230 determines the magnitude of the discrete frequency spectrum T(w), i.e., by Fourier Transformation (e.g., short-window FT) of the interpolated seismic trace, calculates the natural logarithm (or regular logarithm) of this instantaneous spectrum, and then performs a second Fourier Transform on the values obtained from the logarithm calculation to produce the Cepstrum. In some cases, an inverse Fourier Transform on the values obtained from the logarithm calculation may also produce a useable Cepstrum. The real Cepstrum C(t) ranges from −tₘₐₓ to +tₘₐₓ, and is symmetric about the origin t=0.

Under certain parameter conditions, the Cepstrum calculation segregates the reflection energy and some noise from the remainder of the signal (i.e. the Smooth Signal). Accordingly, the desired Smooth Signal information can be extracted in the Cepstrum domain as the values between t_{LOW} and t_{HIGH}. The seismic source type and other measurement conditions may affect the optimal values of t_{LOW} and t_{HIGH}. In one embodiment, t_{HIGH}, for example, may be a positive number fixed at 40% of tₘₐₓ, and t_{LOW}, for example, may be a negative number having a magnitude approximately equal to that of t_{HIGH}. The values of t_{LOW} and t_{HIGH} may be interactively adjusted based on the seismic source type (e.g., Vibroseis, dynamite, or air gun).

In block 604, system 230 zeroes all real Cepstrum values outside the range t_{LOW} to t_{HIGH}, thereby obtaining a Smooth Signal Cepstrum SS(t). In block 606, system 230 calculates the Smooth Signal Spectrum A(ω) from the Smooth Signal Cepstrum SS(t) as follows:

A(ω)=exp[FT⁻¹{SS(t)}] (5)

In words, system 230 performs an inverse Fourier Transform on the Smooth Signal Cepstrum SS(t), and exponentiates each of the transform coefficients to obtain the Smooth Signal Spectrum A(ω). If an inverse Fourier Transform was performed as shown in equation 4, then a forward Fourier Transform should be performed here.

Though the foregoing methods and operations have been described with respect to seismic trace data having a time axis, they may readily be adapted to seismic trace data having a depth axis.

In accordance with some embodiments of the invention, the Smooth Signal Spectra calculated can be output in 3D graphic formats to facilitate analysis. Typically, these 3D graphs correspond to the time, frequency, and amplitude dimensions. Any known 3D digital output format may be used with embodiments of the invention, such as SEGY format (Barry et al., “Recommended Standards for Digital Tape Formats,” Digital Tape Standards, Society of Exploration Geophysics, 1980).

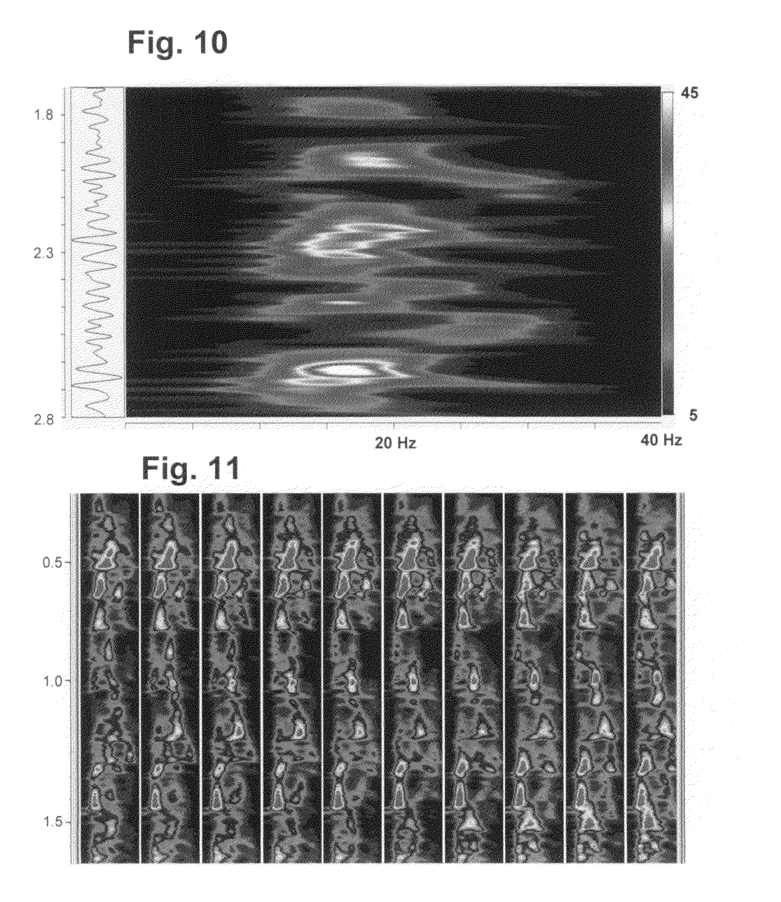

FIG. 10 shows one examples of a 3D graph output, illustrating a contour plot of amplitudes of the Smooth Signal Spectra as functions of time (X-axis) and Seismic frequency (Y axis). A seismic amplitude trace is plotted along the Y axis for reference.

FIG. 11 shows another 3D graphic display in accordance with another embodiment of the invention. As shown in FIG. 11, a plurality of the 3D graphic display may be strung together to create a sectional view, representing a section (a slice) of the region (volume) of interest. Several of these sectional (slice) views may be further strung together to form a cube (not shown), representing the volume of interest.

Some embodiments of the invention relate to systems for hydrocarbon detection based on methods described above. A system in accordance to embodiments of the invention may include a processor and a memory, such as that illustrated in a block diagram as 230 in FIG. 2. The memory of such a system may store a program for performing any of the methods described above. Such a system may be embodied in any suitable computing equipment, including a personal computer.

While specific embodiments of the invention have been disclosed and described above, the invention is not limited by the discussion, but instead is limited only by the scope of the appended claims.

What is claimed is:

1. A method for detecting hydrocarbons, comprising:
obtaining seismic trace data for a region of interest; and
processing the seismic trace data to calculate a Smooth Signal Spectrum for each of a plurality of locations in the region of interest.

2. The method of claim 1, wherein said processing comprises:
transforming a discrete frequency spectra into a corresponding Cepstrum;
separating Smooth Signal information in the Cepstrum from reflection energy, thereby creating a Smooth Signal Cepstrum; and
determining a corresponding Smooth Signal Spectrum from the Smooth Signal Cepstrum.

3. The method of claim 1, wherein the processing comprises calculating a plurality of dominant frequencies (ω_{D}) for the plurality of locations in the region of interest from the Smooth Signal Spectra.

4. The method of claim 3, wherein the processing comprises calculating a trend or background function to identify anomaly from the plurality of the ω_{D}.

5. The method of claim 1, wherein the processing comprises calculating a plurality of breadths (Q_{B}) for the plurality of locations in the region of interest from the Smooth Signal Spectra.

6. The method of claim 5, wherein the processing comprises calculating a trend or background function to identify anomaly from the plurality of Q_{B}.

7. The method of claim 5, wherein the Q_{B} is expressible as:
Q_{B}=ω₃−ω₁, wherein ω₁ and ω₃ correspond to the frequencies of two points on a curve of the Smooth Signal Spectrum where the curve crosses the noise-to-signal ratio.

8. The method of claim 5, wherein Q_{B} is expressible as computing a line integral along a curve of the Smooth Signal Spectrum between the points ω₁ and ω₃ which may be expressed as:
Q_{B}= [symbol] _{ω}_{₁}^{ω}^{₃}A(ω)d ω,
wherein ω is frequency, A(ω) is amplitude at frequency ω, ω₁ and ω₃ correspond to the frequencies of two points on a curve of the Smooth Signal Spectrum where the curve crosses the noise-to-signal ratio.

9. The method of claim 1, further comprising outputting the Smooth Signal Spectrum for each of the plurality of locations in a three-dimensional format, which corresponds to time, frequency, and amplitude dimensions.

10. The method of claim 9, further comprising stringing together the Smooth Signal Spectrum for each of the plurality of locations in the three-dimensional format to form a sectional view.

11. The method of claim 10, further comprising stringing together a plurality of the sectional views to form a three-dimensional cube representing the region of interest.

12. The method of claim 1, wherein said processing comprises padding the trace intervals with zero values to produce extended trace intervals and performing a Fourier Transform on the extended trace intervals to determine discrete frequency spectra.

13. A system for detecting hydrocarbons, comprising a processor and a memory, wherein the memory comprises a program having instructions for:
obtaining seismic trace data for a region of interest; and
processing the seismic trace data to calculate a Smooth Signal Spectrum for each of a plurality of locations in the region of interest.

14. The system of claim 13, wherein said processing comprises:
transforming a discrete frequency spectra into a corresponding Cepstrum;
separating Smooth Signal information in the Cepstrum from reflection energy, thereby creating a Smooth Signal Cepstrum; and
determining a corresponding Smooth Signal Spectrum from the Smooth Signal Cepstrum.

15. The system of claim 13, wherein the processing comprises calculating a plurality of dominant frequencies (ω_{D}) for the plurality of locations in the region of interest from the Smooth Signal Spectra.

16. The system of claim 13, wherein the processing comprises calculating a trend or background function to identify anomaly from the plurality of the ω_{D}.

17. The system of claim 13, wherein the processing comprises calculating a plurality of breadths (Q_{B}) for the plurality of locations in the region of interest from the Smooth Signal Spectra.

18. The system of claim 17, wherein the processing comprises calculating a trend or background function to identify anomalies from the plurality of Q_{B}.

19. The system of claim 17, wherein the Q_{B} is expressible as:
Q_{B}=ω₃−ω₁, wherein ω₁ and ω₃ correspond to the frequencies of two points on a curve of the Smooth Signal Spectrum where the curve crosses the noise-to-signal ratio or a threshold corresponding to a selected percent of the maximum amplitude of the Smooth Signal Spectrum.

20. The system of claim 17 wherein Q_{B} is expressible as computing a line integral along a curve of the Smooth Signal Spectrum between the points ω₁ and ω₃ which may be expressed as:
Q_{H}= [symbol] _{ω}_{₁}^{ω}^{₃}A(ω)d ω,
Where ω is frequency, A(ω) is amplitude at frequency ω, ω₁ and ω₃ correspond to the frequencies of two points on a curve of the Smooth Signal Spectrum where the curve crosses the noise-to-signal ratio or a threshold corresponding to a selected percent of the maximum amplitude of the Smooth Signal Spectrum.
